(19) United States
(12) Patent Application Publication
(10) Pub. No.: US 2019/0050412 A1
(43) Pub. Date: Feb. 14, 2019

(54) INFORMATION MANAGEMENT APPARATUS, INFORMATION MANAGEMENT METHOD, AND INFORMATION MANAGEMENT SYSTEM

(71) Applicant: Mitsubishi Electric Corporation, Chiyoda-ku (JP)

(72) Inventor: Kayo NAGAO, Tokyo (JP)

(73) Assignee: Mitsubishi Electric Corporation, Chiyoda-ku (JP)

(21) Appl. No.: 16/080,178

(22) PCT Filed: Apr. 14, 2016
(86) PCT No.: PCT/JP2016/062042

§ 371 Date: Aug. 27, 2018

(51) Int. Cl. G06F 17/30; G05B 19/418; G05B 19/05; G06F 3/0486

(52) U.S. Cl. CPC G06F 17/30091; G05B 19/418; G05B 2219/13144; G06F 3/0486; G05B 19/056

(57) ABSTRACT

An information management apparatus includes: a registration processing unit to receive component information obtained by modularizing information related to a system, generate relationship information indicating a relationship between the received component information and one or a plurality of pieces of another component information, and store the component information related to the relationship information in a storage unit together with the generated relationship information; and an information analysis unit that is a display screen generation unit to display each piece of the component information stored in the storage unit on a display unit by representing, on the basis of the relationship information, each piece of the component information in a form that allows a relationship with the another component information to be visually identified.

### FIELD

The present invention relates to an information management apparatus, an information management method, and an information management system for managing information required to build a factory automation (FA) system.

### BACKGROUND

Factory automation (hereinafter referred to as FA) systems are realized by a combination of a large number of FA devices, each of which requires settings, programs, and the like. The pieces of information such as settings and programs of these FA devices are becoming increasingly modularized and structured in order to facilitate reuse of such information. A user manages these pieces of information as assets required at the time of building FA systems the next time.

However, these modularized pieces of information are information with various granularities such as a set of setting data for one factory equipment line, setting data for one system including a plurality of devices, a project of one device, a plurality of screen settings, one program, a part of the operation of a program extracted, and the like. Here, a project refers to data required for the operation of the device, specifically data including a program for operating the device, control information for controlling the device, and the like. The device executes an operation according to the projects being set by setting various parameters to be used for each project.

In addition, the modularized pieces of information have various relationships with one another. For example, one piece of information has an inclusive relationship with another piece of information or a combination of information having some relevance to each other exists. A system that manages settings, programs, and the like of FA devices for future use has a challenge of facilitating checking of whether or not the information being managed includes required information, checking for the relationship between the information, and the like. By solving the challenge, the existing information can be diverted efficiently and thus the workload of, for example, building and modifying the FA system can be reduced.

Patent Literature 1 describes an invention that centralizes information used in the control of FA devices as tags to allow for easy reuse of the tags.

### CITATION LIST

### Patent Literature

Patent Literature 1: Japanese Application Laid-open No. 2004-227460

### SUMMARY

### Technical Problem

However, the invention described in Patent Literature 1 manages only the information used in the control of the FA devices and cannot manage other information. In addition, relevance between the information being managed is not taken into account, which makes efficient reuse of the information difficult.

On the other hand, one can manage various types of information, for example, by using a general-purpose folder management tool or the like to manage the information in a hierarchical structure individually or to appropriately determine the names of folders to be managed. Components of different granularities can also be managed. However, when the information is managed using the folder management tool or the like, operators except the operator who assigns the folder names have a hard time finding required information and finding slave data, namely information with fine granularity, contained in master data, namely information with coarse granularity. Moreover, when the slave data is saved individually, the relationship thereof with the master data is unknown; therefore, reuse of such data takes time.

The present invention has been made in view of the above, and an object of the invention is to obtain an information management apparatus that can achieve efficient reuse of information used in an FA system.

### Solution to Problem

In order to solve the above problems and achieve the object, an information management apparatus according to an aspect of the present invention includes: a registration processing unit to receive component information obtained by modularizing information related to a system, generate relationship information indicating a relationship between the received component information and one or a plurality of pieces another component information, and store the component information related to the relationship information in a storage unit together with the generated relationship information; and a display screen generation unit to display each piece of the component information stored in the storage unit on a display unit by representing, on a basis of the relationship information, each piece of the component information in a form that allows a relationship with the another component information to be visually identified.

### Advantageous Effects of Invention

The information management apparatus according to the present invention can achieve efficient reuse of information used in the FA system.

### BRIEF DESCRIPTION OF DRAWINGS

FIG. 1 is a diagram illustrating an example of the configuration of an information management apparatus according to an embodiment of the present invention.

FIG. 2 is a diagram illustrating an example of component information according to the embodiment.

FIG. 3 is a diagram for explaining an example of relationship information according to the embodiment.

FIG. 4 is a diagram for explaining an example of the relationship information according to the embodiment.

FIG. 5 is a diagram illustrating the hardware configuration of the information management apparatus according to the embodiment.

FIG. 6 is a diagram illustrating an example of a screen that the information management apparatus displays on a display unit when performing user authentication according to the embodiment.

FIG. 7 is a diagram illustrating an example of a screen that the information management apparatus according to the embodiment displays on the display unit when allowing a user to select a menu.

FIG. 8 is a diagram illustrating an example of a screen that the information management apparatus according to the embodiment displays on the display unit when allowing a user to input a group name of component information.

FIG. 9 is a diagram illustrating an example of the operation of the information management apparatus when an operation of registering the component information according to the embodiment is performed.

FIG. 10 is a flowchart illustrating an example of the operation in which the information management apparatus according to the embodiment registers the component information and relationship information on a data server.

FIG. 11 is a flowchart illustrating an example of the operation in which a registration processing unit of the information management apparatus according to the embodiment generates the relationship information.

FIG. 12 is a diagram illustrating an example of a screen that the information management apparatus according to the embodiment displays on the display unit after completing registration of the component information.

FIG. 13 is a diagram illustrating an example of display of the component information according to the embodiment and an example of content of the relationship information and setting information associated with the component information.

FIG. 14 is a diagram illustrating an example of display of the component information according to the embodiment and an example of content of the relationship information and setting information associated with the component information.

FIG. 15 is a diagram illustrating an example of the operation of browsing the component information according to the embodiment.

FIG. 16 is a diagram illustrating an example of the operation for changing the relationship between the component information according to the embodiment.

FIG. 17 is a diagram illustrating an example of the operation for changing the relationship between the component information according to the embodiment.

FIG. 18 is a diagram illustrating an example of the operation of duplicating the component information according to the embodiment.

FIG. 19 is a diagram illustrating an example of the operation of changing the setting information according to the embodiment.

FIG. 20 is a diagram illustrating an example of the operation of changing association information and the setting information according to the embodiment.

FIG. 21 is a diagram illustrating an example of a screen that the information management apparatus according to the embodiment displays on the display unit when setting an access right.

FIG. 22 is a diagram illustrating an example of the configuration of an information management system according to the embodiment.

FIG. 23 is a diagram illustrating another example of the configuration of an information management system according to the embodiment.

### DESCRIPTION OF EMBODIMENT

An information management apparatus, an information management method, and an information management system according to embodiments of the present invention will now be described in detail with reference to the drawings. Note that the present invention is not limited to the embodiments.

### Embodiment

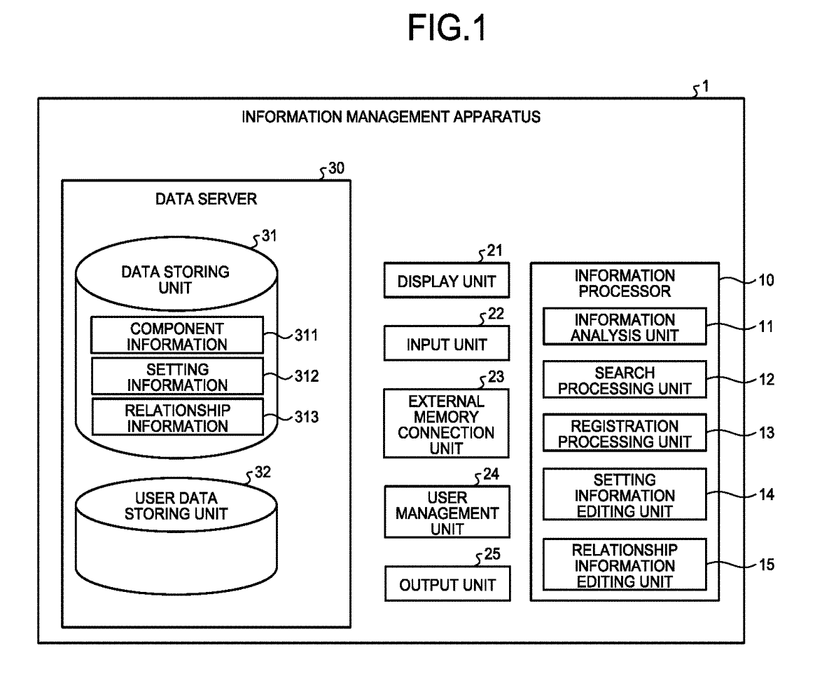

FIG. 1 is a diagram illustrating an example the configuration of an information management apparatus according to an embodiment of the present invention.

An information management apparatus 1 includes a data server 30 and manages information related to an FA system. Information to be managed is modularized for easy reuse thereof. Here, modularization means to put together information related to a certain FA device, such as an operation program, a specification, and a manual, as one piece of information or to extract part of a certain piece of information that can be diverted such as a part of a program for controlling the FA device that is related to a part of the function of the FA device and make the extracted part into another information. The information related to the FA system corresponds to, but is not limited to, a design document of the FA system, the specification of the FA devices included in the FA system, a program for operating the FA devices, parameters of the FA devices, and the like. The information may be any information related to the FA system. The information may also be information indirectly related to the FA system. In the following description, various pieces of information related to the FA system that are modularized and managed by the information management apparatus 1 will be referred to as component information.

The configuration of the information management apparatus 1 will be described. The information management apparatus 1 includes an information processor 10, a display unit 21, an input unit 22, an external memory connection unit 23, a user management unit 24, an output unit 25, and the data server 30. The information processor 10 includes an information analysis unit 11, a search processing unit 12, a registration processing unit 13, a setting information editing unit 14, and a relationship information editing unit 15. The information management apparatus 1 acquires information related to an FA system from an external device and executes processing of writing the acquired information in the data server 30, processing of displaying the information related to the FA system that is stored in the data server 30 on the display unit 21 and allowing a user to check the information, and the like.

In the information processor 10 of the information management apparatus 1, the information analysis unit 11 analyses the information acquired from an external device and the information read from the data server 30. The search processing unit 12 searches for information satisfying a condition from the information stored in the data server 30. The registration processing unit 13 registers information specified by a user, i.e., the information related to the FA system, the data server 30. The setting information editing unit 14 edits setting information to be described later. The relationship information editing unit 15 edits relationship information to be described later. The setting information editing unit 14 and the relationship information editing unit 15 make up an information editing unit.

In the information management apparatus 1, the display unit 21 displays various operation menu screens for a user to use the information management apparatus 1, a confirmation screen for the information stored in the data server 30, a confirmation screen for the information acquired from an external device, and the like. The input unit 22 receives an input operation by a user, specifically, an operation of selecting an action to be executed, an operation of editing information displayed on the display unit 21, and the like. The external memory connection unit 23 is an interface for connecting a detachable external memory. The user management unit 24 performs processing of externally acquiring information on a user of the information management apparatus 1, processing of determining whether or not to permit the user to use various functions of the information management apparatus 1, and the like. The output unit 25 performs processing of reading information stored in the data server 30 and outputting the information to a work area of a storage (not illustrated), and the like. Note that instead of including the display unit 21 in the information management apparatus 1, the information management apparatus 1 may include a connection unit for connecting an external display and may be configured to display various screens on the external display connected via the connection unit.

The data server 30 includes a data storing unit 31 and a user data storing unit 32.

In the data server 30 of the information management apparatus 1, the data storing unit 31 stores component information 311, setting information 312, and relationship information 313. The component information 311 is modularized information related to an FA system and is generated and edited by an application or the like outside the information management apparatus 1. The component information 311 is stored in the form in which it is originally acquired from an external device by the information management apparatus 1.

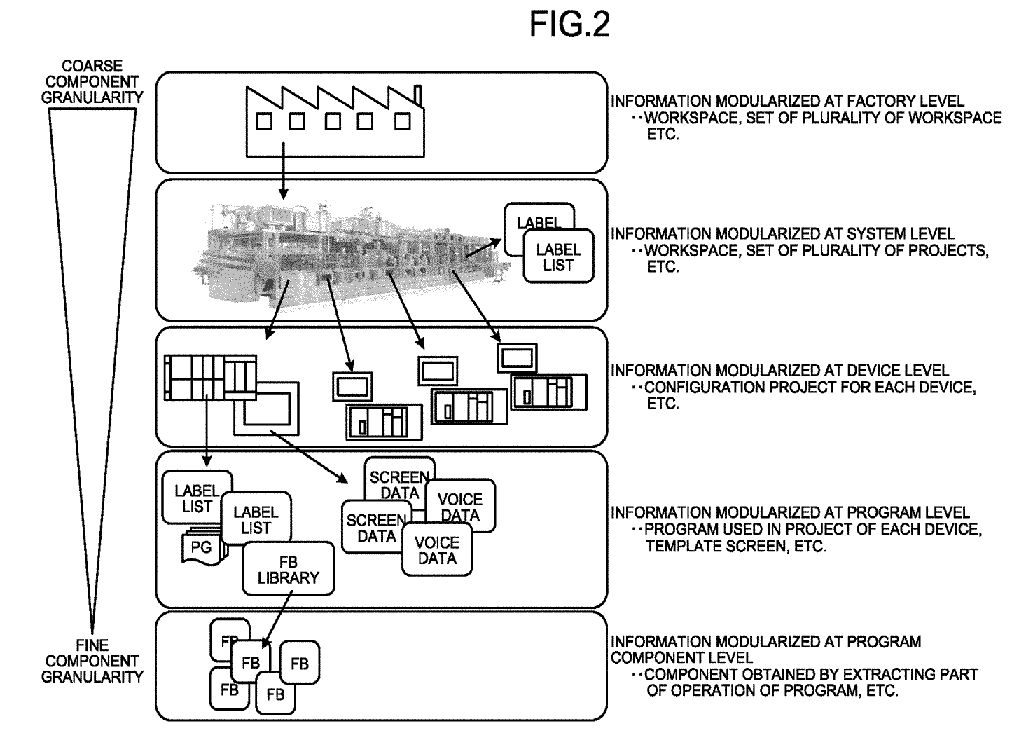

Details of the component information 311 will be described with reference to FIG. 2. FIG. 2 is a diagram illustrating an example of the component information. The component information 311 stored in the data storing unit 31 of the data server 30 includes a plurality of types of information with different granularities. As illustrated in FIG. 2, the component information 311 includes information modularized at a factory level, information modularized at a system level, information modularized at device level, information modularized at a program level, and information modularized at a program component level. The granularity of these pieces of component information that are modularized information satisfies the following relationship: the component information at the factory level 2>the component information at the system level>the component information at the device level>the component information at the program level>the component information at the program component level. Note that the levels in FIG. 2 are illustrated as examples and information modularized at other levels may be included as the component information 311.

The component information at the factory level corresponds to a workspace, a set of a plurality of workspaces, a specification of a workspace, and the like. The workspace is information configured to include a plurality of projects. The component information at the system level corresponds to a workspace, a set of a plurality of projects, a specification of the system, and the like. The component information at the device level corresponds to a project of each device, a specification of the project, and the like. The component information at the program level corresponds to a program used in the project of each device, a specification of the program, template screen data, voice data, and the like. The component information at the program component level corresponds to a function brook (FB) that is a component obtained by extracting a part of the operation of a program, and the like. Note that pieces of the component information with finer granularities included in each piece of component information have some relevance to each other. For example, component information at the program level on a program for operating a certain FA device includes component information generated by extracting a part of processing of the program.

The setting information is information associated with one of the component information 311 and is, for example, information indicating the settings of a project of an FA device in a case where the component information associated is the project. Communication settings and the like of an FA device equipped with a communication function also correspond to the setting information 312. Note that some pieces of the component information 311 are not associated with the setting information 312.

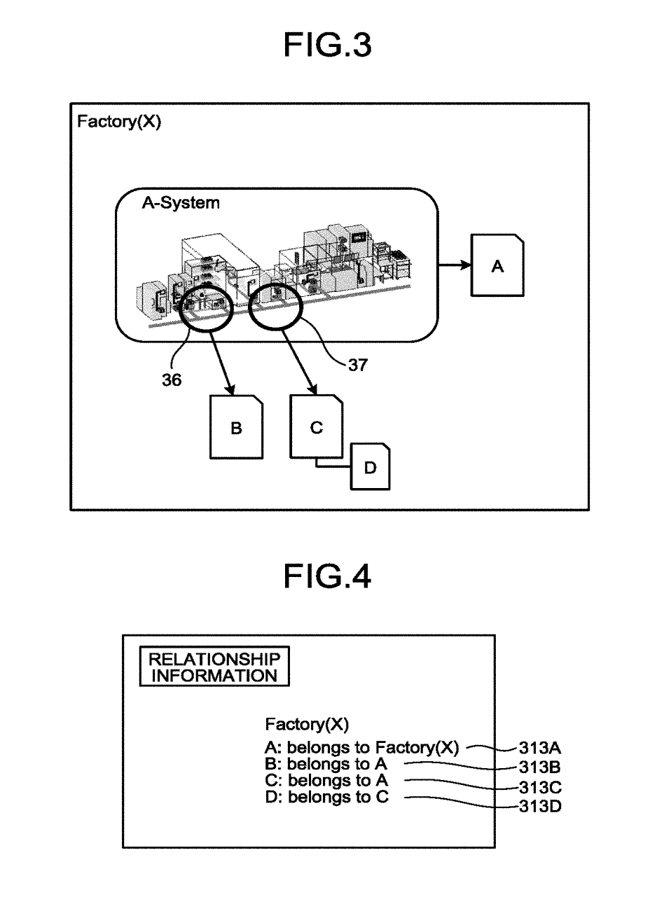

The relationship information 313 is information indicating the relationship among a plurality of pieces of the component information 311 stored in the data storing unit 31. The relationship information 313 is associated with one or a plurality of pieces of the component information 311. The relationship information 313 is generated by the information processor 10 of the information management apparatus 1 and is associated with the component information 311. An example of the relationship information 313 will be described with reference to FIGS. 3 and 4. FIGS. 3 and 4 are diagrams for explaining an example of the relationship information.

Reference characters “A”, “B”, “C”, and “B” in FIG. 3 indicate component information on A-System making up the FA system of Factory (X) or component information on devices and the like included in A-system. The information A, or the component information A, is information obtained by modularizing all the information related to A-System, the information B is information obtained by modularizing all the information related to a device 36 included in A-system, the information C is information obtained by modularizing all the information related to a device 37 included in A-system, and the information D is information obtained by modularizing all the information related to part of the information related to the device 37, such as project of the device 37. In the example illustrated in FIG. 3, the information A and the information B have a master-slave relationship, the information A and the information C have a master-slave relationship, and the information C and the information D have a master-slave relationship. FIG. 4 illustrates the relationship information associated with each of the information A, B, C, and D illustrated in FIG. 3. Relationship information 313A illustrated in FIG. 4 is the relationship information associated with the information A. The relationship information 313A indicates that the information A belongs to Factory (X). Relationship information 3132 illustrated in FIG. 4 is the relationship information associated with the information B. The relationship information 313B indicates that the information B belongs to the information A, or the information B has a master-slave relationship with the information A. Relationship information 3130 illustrated in FIG. 4 is the relationship information associated with the information C. The relationship information 313C indicates that the information C belongs to the information A. Relationship information 313D illustrated in FIG. 4 is the relationship information associated with the information D. The relationship information 313D indicates that the information D belongs to the information C. Note that the relationship information 313 has the configuration illustrated in FIG. 4 as an example and may thus have any configuration as long as the information allows one to recognize the relationship between the component information 311, i.e., the information allows one to recognize the master-slave relationship between each component information 311 and any of the other component information 311.

The component information 311, the setting information 312, and the relationship information 313 are stored in the data storing unit 31 while being associated with one another as described above. These information may be associated with one another using any method. For example, one possible method may be to associate the information by assigning the same identification information (ID) to the component information 311, the setting information 312, and the relationship information 313 that need to be associated with one another, but another method may be used.

The user data storing unit 32 of the data server 30 stores information on a user of the information management apparatus 1, specifically information such as a user ID, a password, and an access right assigned to the user who has permission to use the information management apparatus 1.

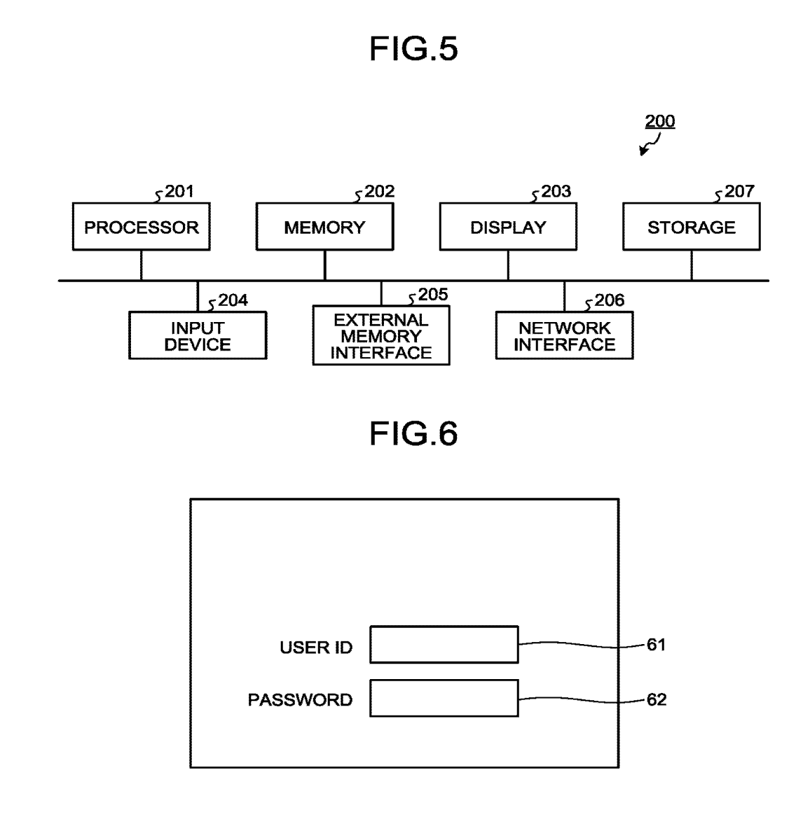

Next, the configuration of hardware implementing the information management apparatus 1 will be described. The information management apparatus 1 can be implemented by hardware 200 illustrated in FIG. 5, or a processor 201, a memory 202, a display 203, an input device 204, an external memory interface 205, a network interface 206, and a storage 207. The hardware 200 is a personal computer, for example.

The processor 201 can be a central processing unit (CPU), a system large scale integration (LSI), or the like. The CPU is also referred to as a processing unit, an arithmetic unit, a microprocessor, a microcomputer, a processor, or a DSP. The processor 201 implements the information processor 10 by reading, from the memory 202, and executing a program for the processor 201 to operate as the information management apparatus 1.

The memory 202 can be a non-volatile or volatile semiconductor memory, such as a random access memory a read only memory (ROM), a flash memory, an erasable programmable read only memory (EPROM), or an electrically erasable programmable read only memory (EEPROM), a magnetic disk, a flexible disk, an optical disk, a compact disc, a mini disc, a digital versatile disc (DVD), or the like. The memory 202 stores the program for the processor 201 to operate as the information management apparatus 1. The memory 202 is also used as a work memory when the processor 201 executes various processings.

The display 203 is a liquid crystal monitor or the like and makes up the display unit 21 illustrated in FIG. 1. The input device 204 is a mouse, a keyboard, or the like and makes up the input unit 22 illustrated in FIG. 1. The external memory interface 205 is an interface for connecting an external memory and makes up the external memory connection unit 23 illustrated in FIG. 1. The network interface 206 is a network interface card or the like, and used when the information management apparatus 1 communicates with external other devices. The storage 207 is a hard disk or the like and makes up the data storing unit 31 and the user data storing unit 32 of the data server 30.

Next, the operation of the information management apparatus 1 will be described. In the present embodiment, the description will be made separately for: a component information registration operation that is an operation of newly registering component information in the data server 30 of an information management system 100; a component information browsing operation that is an operation of searching for required component information from the component information registered in the data server 30 and, for example, displaying, on the display unit 21, the information; an information changing operation of changing the relationship information and the setting information registered in the data server 30; and other operations.

<Component Information Registration Operation>

The information management apparatus 1 displays an initial screen for starting the operation of the information management apparatus 1 on the display unit upon detecting that a user uses the input unit 22 to perform a predetermined operation, specifically an operation for starting the use of the information management apparatus 1. Any operation may be performed as the predetermined operation as long as the operation can trigger the start of the operation of the information management apparatus 1. Such an operation includes, but is not limited to, pressing of a specific operation button provided on the keyboard as the input unit 22, displaying in advance an icon for providing an instruction to start the operation of the information management apparatus 1 on the display unit 21 and clicking on the icon using the mouse as the input unit 22, and the like.

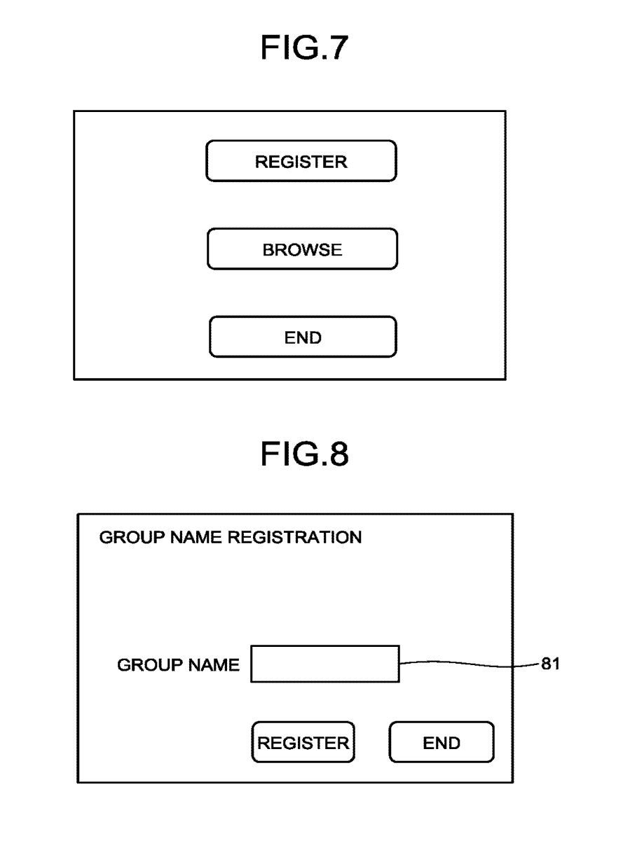

A screen illustrated in FIG. 6 is an example of the initial screen displayed on the display unit 21. When displaying the screen illustrated in FIG. 6 on the display unit 21, the information management apparatus 1 waits for the execution of an operation to input information in a user ID input field 61 and a password input field 62. Upon detecting completion of the operation to input information, the information management apparatus 1 determines whether or not a user ID and a password being input are correct, and displays a screen corresponding to the result of determination on the display unit 21. When a user ID and password are correct, the information management apparatus 1 displays a screen illustrated in FIG. 7 on the display unit 21, for example. The apparatus performs authentication by causing the user to input a user ID and a password in order to limit the users who can use the information management apparatus 1 to a specific user and prevent, for example, unauthorized use of the information management apparatus 1. Note that the information management apparatus 1 may be configured such that it displays the screen illustrated in FIG. 7 immediately after the start of the operation by skipping the operation of displaying the screen illustrated in FIG. 6 on the display unit 21 and causing the user to input a user ID and a password.

The screen illustrated in FIG. 7 is a menu screen that allows the user to select a function to be used by the user, or an operation to be executed by the information management apparatus 1. The menu screen illustrated in FIG. 7 includes a registration button, a browse button, and an end button, but the display content is not limited thereto. The information management apparatus 1 starts the component information registration operation once the registration button is pressed or clicked by the user. Note that when the browse button is pressed, the information management apparatus 1 starts the operation of browsing the component information registered in the data server 30. The information management apparatus 1 terminates the display of the menu screen when the end button is pressed. The information management apparatus 1 in this case returns to the state before the user executes the operation for starting the use of the information management apparatus 1.

Upon starting the component information registration operation, the information management apparatus 1 first displays the screen illustrated in FIG. on the display unit 21 and causes the user to input the name of a component group in which the component information is to be registered. The name of the component group is information required at the time of generating the relationship information associated with the component information. In the case of the relationship information illustrated in FIG. 4, Factory (X) corresponds to the component group name.

The information management apparatus 1 is ready to receive an operation of registering the component information by the user when the operation of registering the component group name is performed, or when information is input to a component group name input field 81 and the registration button is pressed. Note that when an end button displayed on the screen of FIG. 8 is pressed, the information management apparatus 1 returns the display on the display unit 21 to the screen illustrated in FIG. 7.

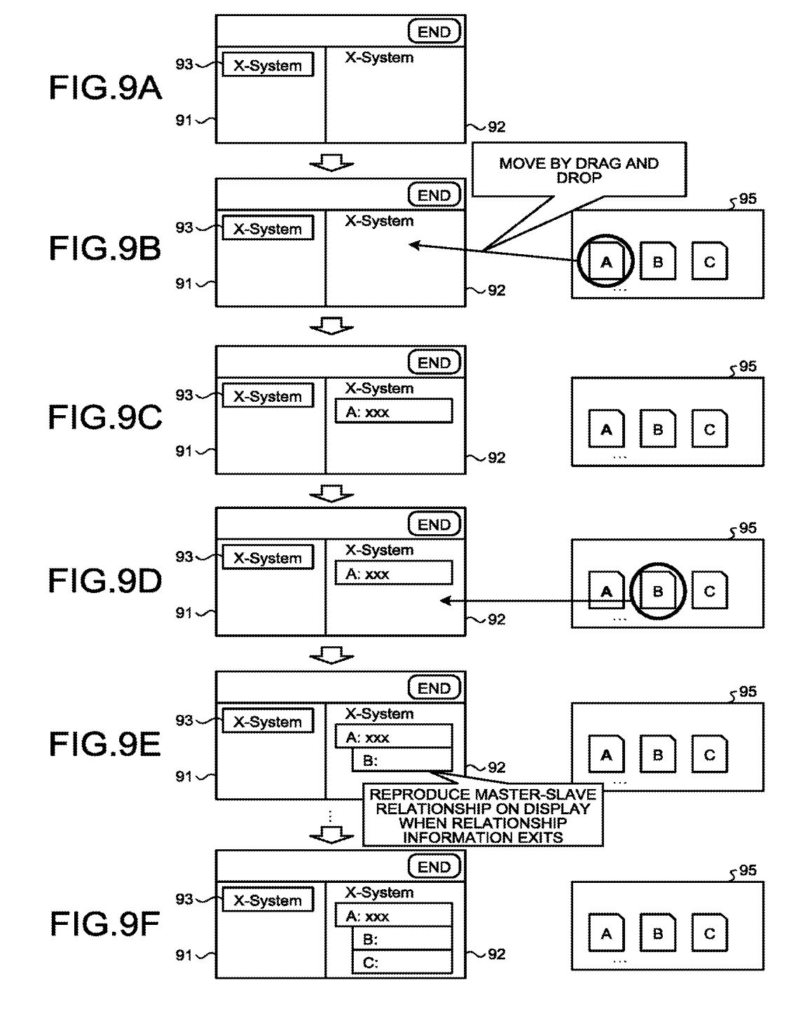

FIG. 9 is a diagram illustrating an example of the operation of the information management apparatus 1 when the operation of registering the component information is performed, i.e., an example of the operation of the information management apparatus 1 after the operation of registering the component group name is performed.

The information management apparatus 1 displays screen as illustrated in FIG. 9(a) on the display unit 1 when the operation of registering the component croup name is performed. Note that the display in FIG. 9 illustrates an example in a case where “X-System” is input as the component group name, in which case a component group name 93 is displayed in a display region 91.

Next, the information management apparatus 1 waits for the user to select component information to be registered and give an instruction to start the registration of the component information being selected

The user may use any operation method to select the component information and give an instruction to start the registration. Here, an example of the operation method will be illustrated. When selecting the component information and giving an instruction to start the registration, the user uses the input unit 22 to perform the component information registration operation by following the procedure illustrated in FIG. 9(b). Specifically, the user first performs an operation of separately displaying a screen 95 for selecting the component information on the display unit 21, and then performs an operation of displaying the component information to be registered on the screen 95 and dragging and dropping one or more pieces of the component information to a display region 92. FIG. 9(b) illustrates an example of the operation when the user selects the component information A and gives an instruction to start the registration.

Note that the component information A, B, and C displayed on the screen 95 of FIG. 9(b) appears to be stored in the same folder for the convenience of description. In practice, the component information A is stored in a folder different from a folder in which the component information B and C is stored. Here, the description will be made here assuming that the component information A is stored in a top-level folder while the component information B and C is stored in a folder one level below the folder that stores the component information A. The component information A, B, and C is stored in an internal memory (not illustrated) in the information management apparatus 1 or an external memory connected to the external memory connection unit 23.

When the component information to be registered is selected by the user, the information management apparatus 1 registers the selected information in the data server 30. In registering the selected component information in the data server 30, the information management apparatus 1 checks the presence or absence of the relationship information associated with the component information to be registered and, if any, registers the relationship information together in the data server 30. When no relationship information is associated with the component information to be registered, the information management apparatus 1 generates relationship information and associates the information with the component information, and then registers the component information and the generated relationship information in the data server 30. The information management apparatus 1 also checks the presence or absence of setting information associated with the component information to be registered and, if any, registers the setting information together with the component information and the relationship information in the data server 30.

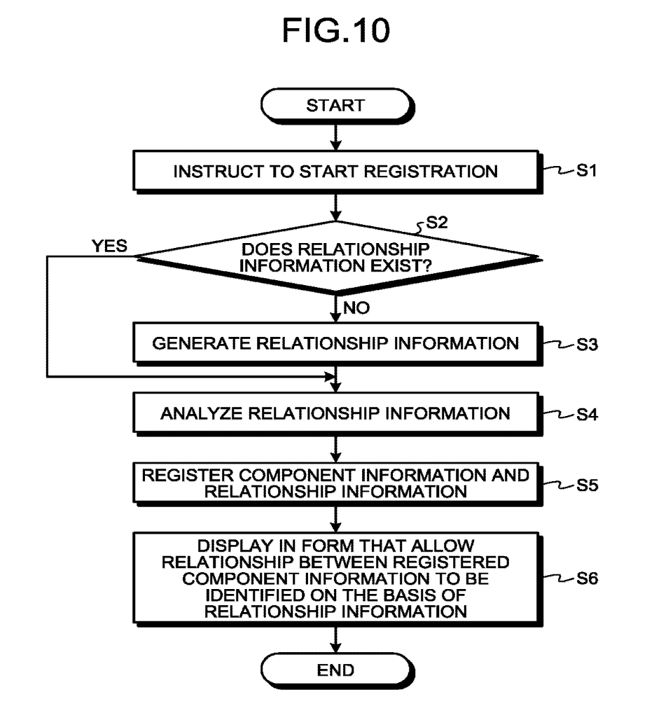

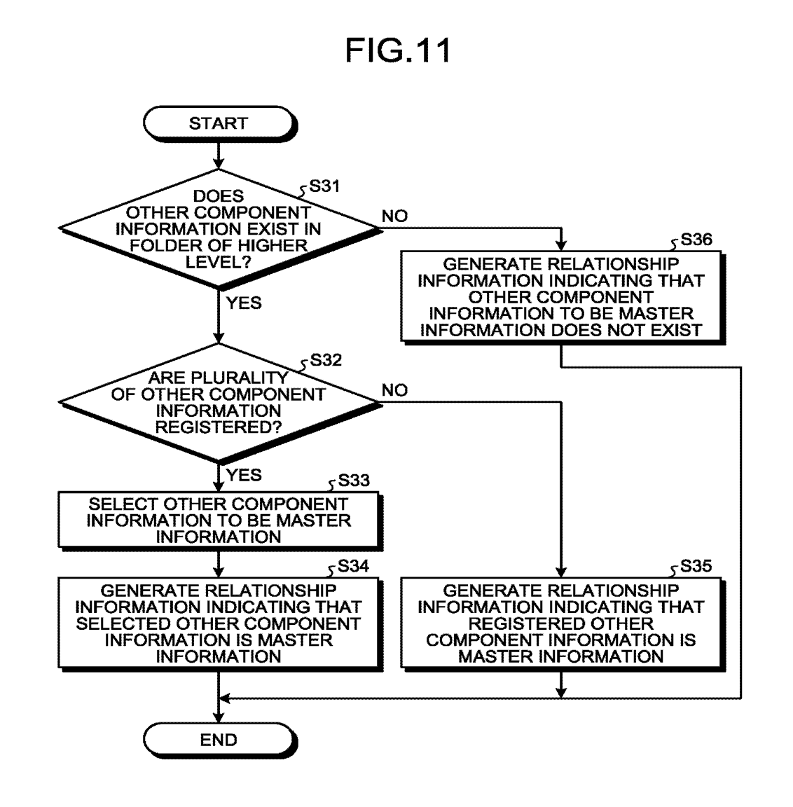

Here, the description will be made, with reference to FIGS. 10 and 11, of details of the operation in which the information management apparatus 1 checks the presence or absence of the relationship information associated with the component information to be registered in the data server 30 and registers the component information and the relationship information in the data server 30.

FIG. 10 is a flowchart illustrating an example of the operation in which the information management apparatus 1 registers the component information and the relationship information in the data server 30.

Upon receiving an instruction to start registration of the component information selected by a user (step S1), the information management apparatus 1 checks the presence or absence of the relationship information associated with the component information to be registered (step S2). The information management apparatus 1 checks the presence or absence of the corresponding relationship information within a storage area or a folder that stores the component information to be registered. If the relationship information associated with the component information to be registered exists in the same folder as the folder storing the component information (Yes in step S2), the information management apparatus 1 analyses the relationship information associated with the component information to be registered (step S4) and checks the relationship between the component information registered in the data server 30. The information management apparatus 1 then registers the component information selected by the user and the relationship information associated therewith in the data server 30 (step S5). Specifically, the information management apparatus 1 stores the component information and the relationship information in the data storing unit 31. Note that the relationship information associated with the component information to be registered exists in the same folder as the folder storing the component information in a case where, for example, the component information registered in the information management system 100 as the component information on Y-System is temporarily output to an external memory or the like and then registered as component information on X-System. As will be described later, when temporarily outputting the component information registered in the information management system 100 to the external memory or the like, the information processing apparatus 1 also outputs relationship information and setting information associated with the component information to be output to an external device while maintaining the association.

If no relationship information is associated with the component information to be registered (No in step S2), the information management apparatus 1 generates relationship information (step S3), analyzes the generated relationship information (step 4), and checks the relationship between the component information registered in the data server 30. The information management apparatus 1 then registers, in the data server 30, the generated relationship information in association with the component information to be registered (step S5). Note that in the information management apparatus 1, the registration processing unit 13 of the information processor 10 performs the processing of steps S2, S3, and S5 described above, and the information analysis unit 11 performs the processing of step S4 described above. In step S1, the registration processing unit 13 generates the relationship information by following the procedure illustrated in FIG. 11. FIG. 11 is a flowchart illustrating an example of the operation in which the registration processing unit 13 of the information management apparatus 1 generates the relationship information.

When the relationship information is to be generated, i.e., when the result of determination in step S2 is “No”, the registration processing unit 13 checks whether or not other component information exists in an upper level folder of the folder that stores the component information to be registered (step S31). Here, the “upper level folder” is a folder that is one level higher than the folder storing the component information to be registered.

If other component information exists in the upper level folder (Yes in step S31), the registration processing unit 13 checks whether or not a plurality of pieces of the other component information are registered in the data server 30 (step S32).

If one piece of the other component information rather than a plurality of pieces of the other component information is registered in the data server 30 (No in step S32), the registration processing unit 13 generates relationship information indicating that the other component information registered in the data server 30 is master information among the other component information in the upper level folder (step S35). When the component information to be registered is information D1 and the component information registered in the upper level is information D0, for example, the registration processing unit 13 generates relationship information indicating that the master information of the information D1 is the information D0. Using the format of the relationship information as illustrated in FIG. 4, the registration processing unit 13 generates “belongs to D0” as the relationship information on the information D1. Note that since the master component information need only be known, the registration processing unit 13 may generate the information “D0” or the like uniquely indicating the master component information as the relationship information.

In contrast, if a plurality of pieces of the other component information are registered in the data server 30 (Yes in step S32), the registration processing unit 13 waits for the user to select the other component information to be the master information and the user selects the other component information to be the master information (step S33). In step S33, the registration processing unit 13 displays, on the display unit 21, the other component information that can be the master information of the component information to be registered, i.e., the other component information registered in the data server 30 among the other component information in the upper level folder, and waits for one piece of the other component information being displayed to be selected.

Once the user cots the other component information to be the master information, the registration processing unit 13 generates relationship information indicating that the selected other component information is the master information (step S34).

If the other component information does not exist in the upper level folder (No in step S31), the registration processing unit 13 generates relationship information indicating the absence of the other component information to be the master information (step S36).

The registration processing unit 13 generates the relationship information by executing the processings illustrated in steps S31 to S36 above.

The description here refers back to the flowchart illustrated in FIG. 10. After completing the registration of the component information and the relationship information by executing the processings in steps S1 to S5, the information management apparatus 1 displays the component information registered in the data server 30 on the display unit 21 in the form that allows the relationship between the component information to be visually identified, in accordance with the result of analysis obtained by executing step S4 (step S6). Note that the component information to be displayed on the display unit 21 is the component information registered in step S5 and other component information related to the component information. That is, the information management apparatus 1 displays the component information registered in step S5 and the component information belonging to the same component group as that registered in step S5 on the display unit 21. Note that in the information management apparatus 1, the information analysis unit 11 of the information processor 10 performs the processing in step S6. The information analysis unit 11 is a display screen generation unit that displays each piece of the component information stored in the data server 30 on the display unit 21 in the form that allows the relationship with the other component information to be visually identified.

The description here refers back to FIG. 9. After executing the operation illustrated in FIG. 9(b) and completing the registration of the component information A, the information management apparatus 1 displays the component information A in the display region 92 as illustrated in FIG. 9(c). No component information exists as the master information of the component information A in the example illustrated in FIG. 9(c); therefore, the information management apparatus 1 displays the component information A immediately below the display of the component group name (X-System). Note that the display “xxxx” next to “A:” indicates the details of setting information associated with the component information A.

The information management apparatus 1 thereafter registers the component information F in the data server 30 when an operation illustrated in FIG. 9(d), i.e., an operation of providing an instruction to start registration of the component information B, is performed. The registration operation is similar to the operation of registering the component information A described above. The component information B is stored in the folder one level below the folder that stores the component information A as described above; therefore, relationship information associated with the component information B indicates that the master information of the component information B is the component information A.

After completing the registration of the component information B, the information management apparatus 1 displays the component information A and B registered in the data server 30 in the display region 92, as illustrated in FIG. 9(e). At this time, the information management apparatus 1 displays the component information A and B registered in the data server 30 such that the master-slave relationship therebetween can be recognized. Because the component information A is a master and the component information B is a slave, the information management apparatus 1 displays the component information B that is the slave in the display region 92 such that it is indented below the display of the component information A, i.e., the head position of the display of the component information B is indented. Such a method of display is merely an example, and thus any display may be adopted as long as the relationship between the component information registered in the data server 30 can be visually identified.

Then, after an operation of providing an instruction to start registration of the component information C is performed and the registration of the component information C is completed, the information management apparatus 1 updates the display on the display unit 21 as illustrated in FIG. 9(f). The component information A is the mater information for both the component information C and the component information B; therefore, the information management apparatus 1 aligns the head of splay of the component information C with the head of display of the component information P.

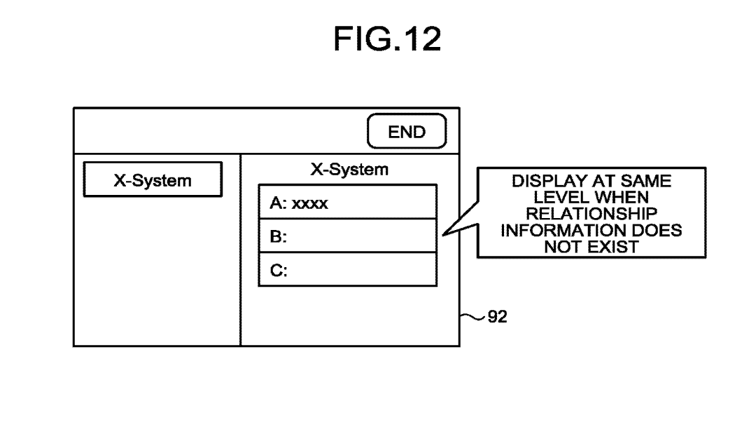

Note that when the component information A, B, and C before registered in the data server 30 exists in the same folder, these pieces of component information do not have a master-slave relationship. Thus, the component information A, B, and C after registered in the data server 30 is displayed on the screen as illustrated in FIG. 12. Specifically, the information management apparatus 1 displays the registered component information A, B, and C at the same level.

Moreover, in order to simplify the description, the component information is selected and registered one by one in the example illustrated in FIG. 9, but a plurality of pieces of the component information can be selected by the user and registered all at once. When a plurality of pieces of the component information are selected, the information management apparatus 1 repeatedly executes the processing illustrated in FIGS. 10 and 11 and registers all the selected component information in the data server 30.

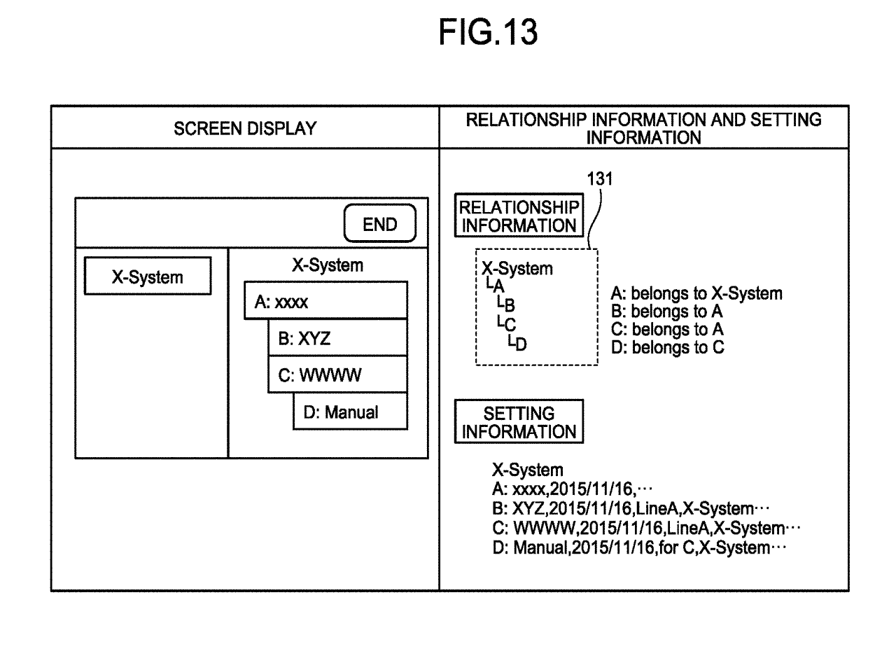

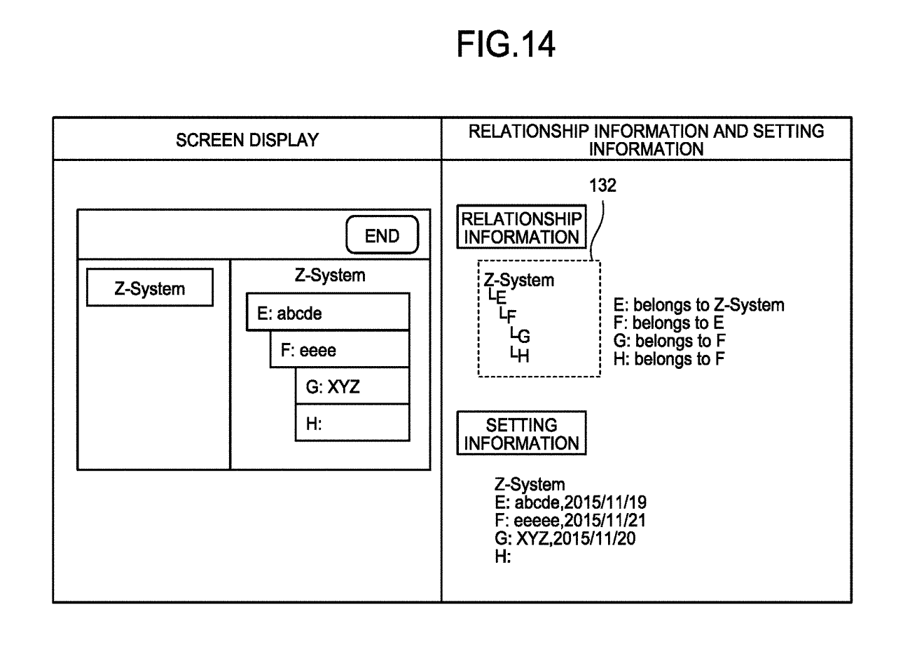

A method of displaying the component information registered in the data server 30 on the display unit 21 will be described with reference to FIGS. 13 and 14. FIGS. 13 and 14 are diagrams each illustrating an example of display of the component information and an example of content of relationship information and setting information that are associated with the component information.

The example illustrated in FIG. 13 will be described first. The display on the left side of FIG. 13 is an example of display on the display unit 21 when the component information A, B, C, and D is registered in the data server 30 as the component information belonging to the “X-system” group. The display on the right side of FIG. 13 includes details of the relationship information and the setting information associated with each piece of the component information displayed on the left side. Note that a display 131 indicates the master-slave relationship among the component information derived from the relationship information associated with each piece of the component information. The display 131 is illustrated for convenience in order to facilitate understanding of the relationship information, and is not included in the relationship information.

The relationship information associated with the component information A is “belongs to X-system”. This relationship information indicates that the component information A does not have other component information to be the master information thereof and thus has the coarsest granularity among the component information belonging to the X-system. Because the component information A has the coarsest granularity, the information management apparatus 1 displays the component information A immediately below the name (X-system) of the group to which the component information A belongs. The setting information associated with the component information A is “xxxx, 2015/11/16, . . . ”. The information management apparatus 1 displays a part or all of the setting information to the right of the display of the name “A” of the component information A with a colon, i.e., “:”, being placed therebetween so that the user can easily understand the details of the setting information associated with the component information A. The example of FIG. 13 displays “xxxx” in the setting information.

The relationship information associated with the component information B is “belongs to A”. This relationship information indicates that the component information A is the master information. Because the master information of the component information B is the component information A, the information management apparatus 1 displays the component information B such that it is indented below the display of the component information A. The setting information associated with the component information B is “XYZ, 2015/11/16, Line A, X-system . . . ”. The information management apparatus 1 displays a part or all of the setting information to the right of the display of the name “B” of the component information B with a colon, i.e., “:”, being placed therebetween so that the user can easily understand the details of the setting information associated with the component information B.

The relationship information associated with the component information C is “belongs to A”. This relationship information indicates that the component information A is the master information. Because the master information of the component information C is the component information A, the information management apparatus 1 displays the component information C such that it is indented below the display of the component information A. The setting information associated with the component information C is “WWWW, 2015/11/16, Line A, X-system . . . ”. The information management apparatus 1 displays a part or all of the setting information to the right of the display of the name “C” of the component information C with a colon, i.e., “:”, being placed therebetween so that the user can easily understand the details of the setting information associated with the component information C.

The relationship information associated with the component information D is “belongs to C”. This relationship information indicates that the component information C is the master information. Because the master formation of the component information D is the component information C, the information management apparatus 1 displays the component information D such that it is indented below the display of the component information C. The setting information associated with the component information D is “Manual, 2015/11/16, for C, X-system . . . ”. The information management apparatus displays a part or all of the setting information to the right of the display of the name “D” of the component information D with a colon, i.e., “:”, being placed therebetween so that the user can easily understand the details of the setting information associated with the component information D.

The example illustrated in FIG. 14 will now be described. The display on the left side of FIG. 14 is an example of display on the display unit 21 when component information E, F, G, and H is registered in the data server 30 as the component information belonging to a “Z-system” group. The display on the right side of FIG. 14 includes details of the relationship information and the setting information associated with each piece of the component information displayed on the left side. Note that a display 132 indicates the master-slave relationship among the component information derived from the relationship information associated with each piece of the component information. The display 132 is illustrated for convenience in order to facilitate understanding of the relationship information, and is not included in the relationship information.

The relationship information associated with the component information E is “belongs to Z-system”. This relationship information indicates that the component information E does not have other component information to be the master information thereof and thus has the coarsest granularity among the component information belonging to the Z-system. Because the component information E has the coarsest granularity, the information management apparatus 1 displays the component information E immediately below the name (Z-system) of the group to which the component information E belongs. The setting information associated with the component information E is “abode, 2015/11/19”. The information management apparatus 1 displays a part or ail of the setting information to the right of the display of the name “E” of the component information B with a colon, i.e., “:”, being placed therebetween so that the user can easily understand the details of the setting information associated with the component information E.

The relationship information associated with the component information F is “belongs to E”. This relationship information indicates that the component information E is the master information. Because the master information of the component information F is the component information E, the information management apparatus 1 displays the component information F such that it is indented below the display of the component information E. The setting information associated with the component information F is “eeeee, 2015/11/21”. The information management apparatus 1 displays a part or all of the setting information to the right of the display of the name “F” of the component information F with a colon, i.e., “:”, being placed therebetween so that the user can easily understand the details of the setting information associated with the component information F.

The relationship information associated with the component information G is “belongs to F”. This relationship information indicates that the component information F is the master information. Because the master information of the component information G is the component information F, the information management apparatus 1 displays the component information G such that it is indented below the display of the component information F. The setting information associated with the component information G is “XYZ, 2015/11/20”. The information management apparatus 1 displays a part or all of the setting information to the right of the display of the name “G” of the component information G with a colon, i.e., “:”, being placed therebetween so that the user can easily understand the details of the setting information associated with the component information G.

The relationship information associated with the component information H is “belongs to F”. This relationship information indicates that the component information F is the master information. Because the master information of the component information H is the component information F, the information management apparatus 1 displays the component information H such that it is indented below the display of the component information F. No setting information is associated with the component information H. The information management apparatus 1 thus displays only a colon, i.e., “:”, to the right of the display of the name “H” of the component information H, and leaves the display of the setting information blank.

The information management apparatus 1 displays the details of the setting information associated with the component information registered in the data server 30, if any, together with the component information, thereby allowing one to easily check the details of the setting information and easily know whether the setting information corresponds to the component information.

<Component Information Browsing Operation>

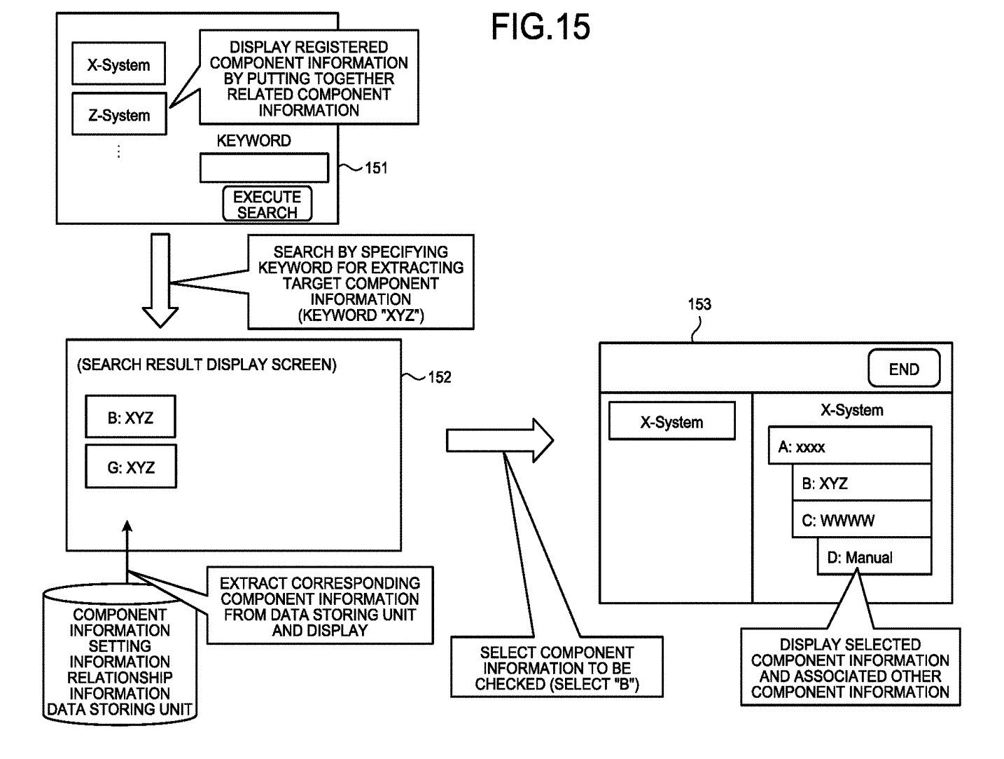

Next, the operation performed when the user browses the component information will be described. The information management apparatus 1 starts the component information browsing operation upon detecting pressing of the browse button while the menu screen illustrated in FIG. 7 is displayed on the display unit 21. The component information browsing operation will be described with reference to FIG. 15. FIG. 15 is a diagram illustrating an example of the component information browsing operation, and the operation performed when component information to be browsed is searched for by using a keyword search and browsed.

Upon starting the component information browsing operation, the information management apparatus 1 first displays a keyword input screen 151 illustrated in FIG. 15 on the display unit 21 and waits for input of a keyword and an instruction to start a search operation. In addition to a text box for entering the keyword, the information management apparatus 1 displays the registered component information on the keyword input screen 151 such that the related component information is put together. The keyword input screen 151 in FIG. 15 is an example in which a component information group related to X-System and a component information group related to Z-System are each displayed as one box. The following description assumes that the component information group related to X-System includes the component information A, B, C, and D illustrated in FIG. 13 and the component information group related to Z-System includes the component information E, F, G, and H illustrated in FIG. 14.

When the input of the keyword and the instruction to start the search operation are made, the information management apparatus 1 searches the data storing unit 31 on the data server 30 for the setting information including the input keyword and displays, on the display unit 21, a search result display screen 152 including the display of component information associated with the found setting information. The search result display screen 152 illustrated in FIG. 15 is a display screen indicating the search result when “XYZ” is entered as the keyword. Of the component information group related to K-System and the component information group related to Z-System, the component information B and G is the information associated with the setting information including “XYZ”, as illustrated in FIGS. 13 and 14. The information management apparatus 1 thus displays the component information B and G on the search result display screen 152. In the information management apparatus 1, the search processing unit 12 executes the processing of searching for the setting information including the input keyword. The search processing itself is similar to typical keyword search processing and thus will not be described. The user selects the component information B or G displayed as the search result, for example, by clicking on the information using a mouse that is the input unit 22, and can check for other component information related to the selected component information.

When one of the search results displayed on the search result display screen 152 is selected, the information management apparatus 1 displays the selected component information and the other component information related thereto as an information confirmation screen 153 on the display unit 21. The information confirmation screen 153 illustrated in FIG. 15 is a display example when the component information B is selected from the search results. Because the component information B is the component information related to X-System, the information management apparatus 1 displays, on the display unit 21, all the component information related to X-System in a form in which one can see the relationship among the component information. The information management apparatus 1 displays the information confirmation screen display 153 according to the display method described with reference to FIGS. 13 and 14.

The information management apparatus 1 is equipped with the search function as described above; therefore, the user can easily find the component information required and easily reuse the component information.

Note that when one component information group is selected, for example, by clicking on the box (the box displaying X-System or the box displaying Z-System) of the component information group while the keyword input screen 151 is displayed on the display unit 21, the information management apparatus 1 expands the selected component information group and displays the information confirmation screen display 153.

<Information Changing Operation>

Next, the operation of changing the relationship information and setting information registered in the data server 30 will be described.

(Relationship Information Changing Operation)

First, the operation of changing the relationship between the component information, i.e., the operation of changing the relationship information associated with the component information, will be described.

Upon detecting that an operation for changing the relationship between the component information is performed while a plurality of pieces of the component information related to each other is displayed on the display unit 21, the information management apparatus 1 updates the content displayed on the screen of the display unit 21 in accordance with the details of the operation, and updates the relationship information registered in the data server 30. In the information management apparatus 1, the relationship information editing unit 15 updates the relationship information.

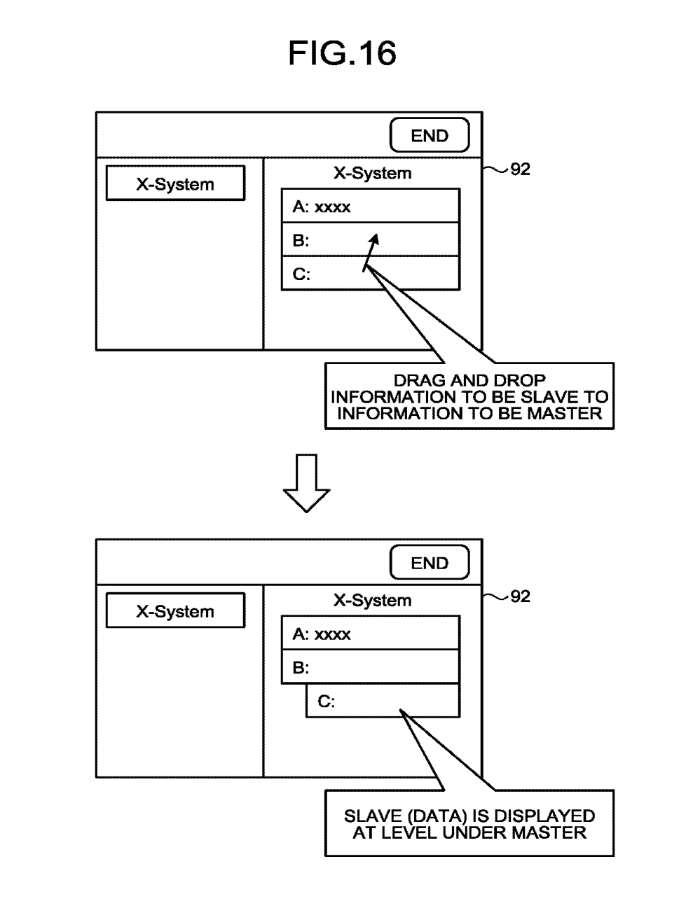

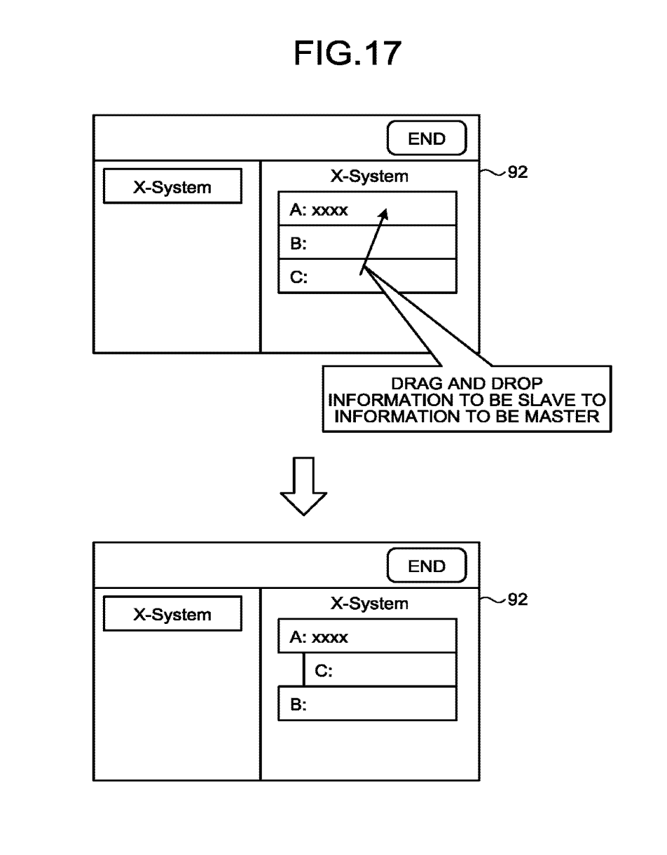

The operation performed by the user to change the relationship between the component information can include operations illustrated in FIGS. 16 and 17 but is not limited thereto. When the relationship between the component information is to be changed, the user changes the relationship between the component information by dragging and dropping while the component information to be changed is displayed on the display unit 21. The user displays the component information to be changed on the display unit 21 by using a keyword search described in the component information browsing operation above or the like.

The example of FIG. 16 illustrates the operation in a case where, among the component information A, B, and C of the same level, the component information C is changed to be the slave information of the component information B. The example of FIG. 17 illustrates the operation in a case where, among the component information A, B, and C of the same level, the component information C is changed to be the slave information of the component information A. The information management apparatus 1 updates the content displayed in the display region 92 and updates the relationship information in accordance with the details of the operation performed by the user. When detecting the operation illustrated in FIGS. 16 and 17, the information management apparatus 1 updates the relationship information associated with the component information C. Specifically, in the example illustrated in FIG. 16, the information management apparatus 1 updates the relationship information associated with the component information C to the content indicating that the component information B is the master information. In the example illustrated in FIG. 17, the information management apparatus 1 updates the relationship information associated with the component information C to the content indicating that the component information A is the master information.

The information management apparatus 1 can thus allow the user to change the relationship between the component information by a simple operation.

Although one piece of component information is operated in the above example, a plurality of pieces component information can be selected and operated collectively. For example, the component information B and C can be selected and changed to be the slave information of the component information A.

The relationship information can also be changed during the operation of registering the component information described with reference to FIG. 9. That is, the information management apparatus 1 allows the user to execute the operation for changing the relationship information described above in the state of FIG. 9(e) or (f) or in the state equivalent thereto. When the operation for changing the relationship information is performed in the state of FIG. 9(e) or (f) or in the state equivalent thereto, the information management apparatus 1 changes the relationship between the component information displayed in the display region 92 in accordance with the details of the operation. The information management apparatus 1 changes the content displayed in the display region 92 and the relationship information in accordance with the details of the operation.

Next, a variation of the relationship information changing operation will be described. The information management apparatus 1 can duplicate the component information registered in the data server 30 as the component information on a certain component group and newly register the information as component information on another component group.

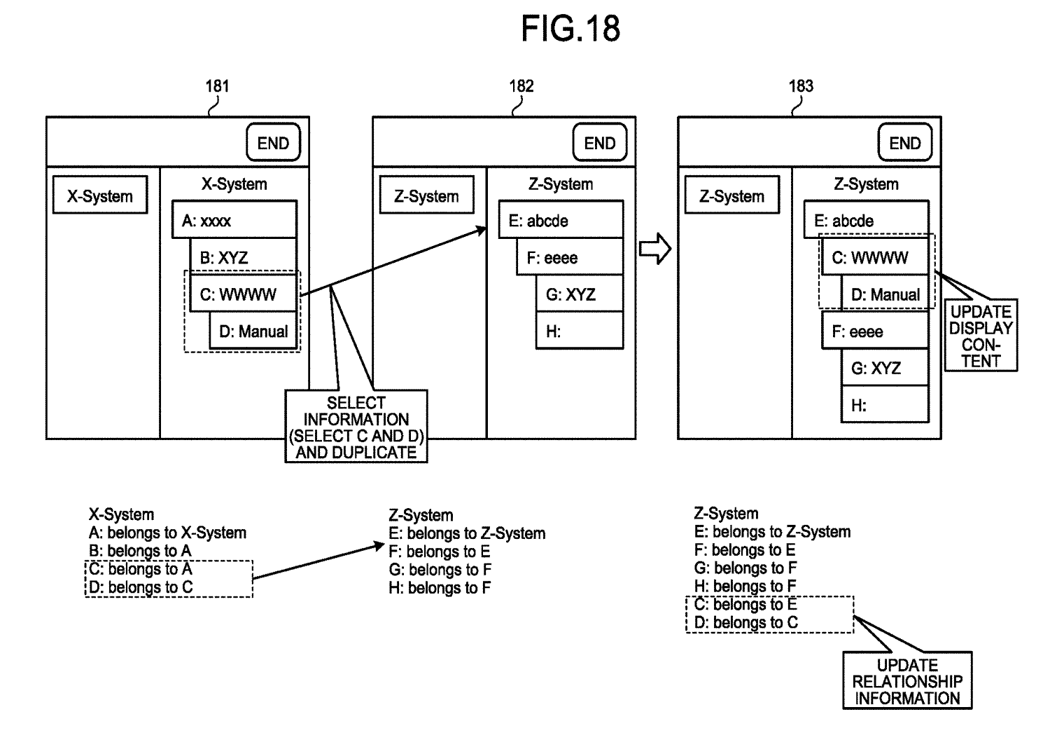

Upon detecting that one or more pieces of component information are selected and that an operation of providing an instruction for duplication and an operation of designating a duplication destination are performed while a plurality of pieces of the component information relevant to each other are displayed on the display unit 21, the information management apparatus 1 updates the content displayed on the screen of the display unit 21 in accordance with the details of the operations, and updates the component information, the setting information, and the relationship information registered in the data server 30. FIG. 18 illustrates an example of the operation. Any operation method may be used to select the component information to be duplicated and provide an instruction to duplicate the selected component information.

FIG. 18 is a diagram illustrating an example the operation of duplicating the component information. In the example illustrated in FIG. 18, the information management apparatus 1 first detects that an instruction to select and duplicate the component information C and D is made while the component information on X-System is displayed as a screen 181 on the display unit 21. The information management apparatus 1 then detects that the duplication destination of the component information C and D is designated while the component information on Z-System is displayed as a screen 182 on the display unit 21. Specifically, the information management apparatus 1 detects that the duplicate component information C and D is designated as the slave information of the component information E. As a result, the information management apparatus 1 updates the content displayed on the display unit 21 to a screen 183 and updates the information registered in the data server 30. Specifically, the information management apparatus 1 duplicates the component information C and D selected to be duplicated as well as the setting information and the relationship information associated with these pieces of component information, thereby additionally registering the duplicate information in the data server 30 as information related to Z-System. In additionally registering the relationship information in the data server 30, the information management apparatus updates the content of the information in accordance with the destination to which the information is added. In the example illustrated in FIG. 18, the relationship information associated with the component information C added to Z-System is updated to “belongs to E”, whereas the relationship information associated with the component information D added to Z-System is left unchanged as “belongs to C” and not updated. The relationship information editing unit 15 updates the relationship information.

(Setting Information Changing Operation)

Next, the operation of changing the setting information registered in the data server 30 will be described.

Upon detecting that an operation for changing the setting information is performed while a plurality of pieces of the component information relevant to each other are displayed on the display unit 21, the information management apparatus 1 changes the content displayed on the screen of the display unit 21 in accordance with the details of the operation, and changes the setting information registered in the data server 30. In the information management apparatus 1, the setting information editing unit 14 changes the setting information.

The operation performed by the user to change the relationship between the component information can include the operations illustrated in FIGS. 16 and 17 but is not limited thereto. When the relationship between the component information is to be changed, the user changes the relationship between the component information by dragging and dropping while the component information to be changed is displayed on the display unit 21. The user displays the component information to be changed on the display unit 21 by using a keyword search described in the component information browsing operation above or the like.

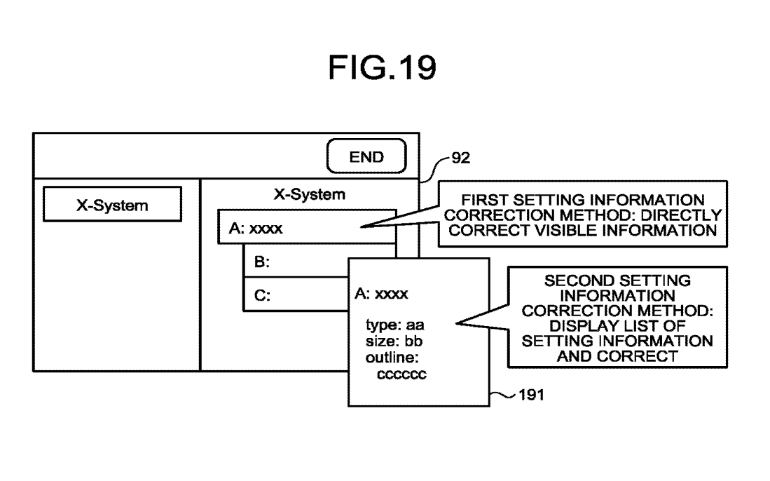

FIG. 19 illustrates an example of the operation of changing the setting information. The information management apparatus 1 can implement a method (first correction method) in which the setting information displayed in the display region 92 is directly corrected by the user and a method (second correction method) in which the setting information is displayed on a separate correction work screen 191 and corrected. The correction work screen 191 is displayed upon detection of the selection of the component information by the user and the operation of providing an instruction to start correction of the setting information. The operation for changing the content of the setting information is the same as a typical text editing operation, and thus will not be described.

(Operation of Changing Relationship Information and Setting Information at the Same Time)

Next, an operation of changing the setting information and the relationship information associated with the component information registered in the data server 30 at the same time will be described.

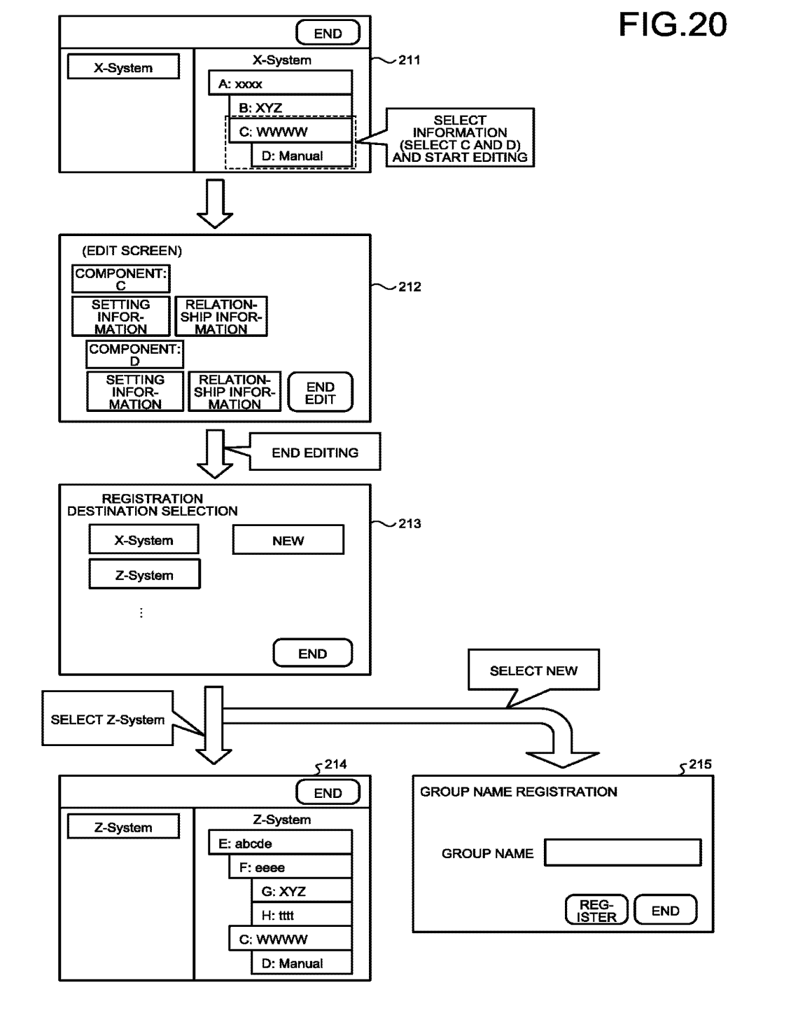

The information management apparatus 1 starts the operation of changing the association information and the setting information upon detecting that an operation for starting the operation of changing the association information and the setting information at the same time is performed while a plurality of pieces of the component information relevant to each other are displayed on the display unit 21. The operation will be described with reference to FIG. 20. FIG. 20 is a diagram illustrating an example of the operation of changing the relationship information and the setting information at the same time.

In the example illustrated in FIG. 20, the information management apparatus 1 first detects selection of the component information C and D and an instruction to start editing while the component information on X-System is displayed as a screen 211 on the display unit 21. When an instruction is made to start editing, the information management apparat displays, on the display unit 21, an edit screen 212 for the relationship information and the setting information, and receives an operation of editing the relationship information and the setting information by the user. The editing operation performed by the user is the same as the typical text editing operation, and thus will not be described.

Upon detecting that an edit end button on the edit screen 212 is pressed, the information management apparatus 1 stops displaying the edit screen 212 on the display unit 21 and displays thereon a registration destination selection screen 213 that allows for selection of a destination in which the edited relationship information and setting information are registered. With the registration destination selection screen 213 displayed on the display unit 21, the information management apparatus 1 waits for the user to select an existing component information group or a new component information group as the destination in which the edited relationship information and setting information are registered.

Upon detecting the selection of the registration destination by the user, the information management apparatus 1 displays a screen with the content corresponding to the selected registration destination on the display unit 21 and updates the information registered in the data server 30.

When the existing component information group is selected, the information management apparatus 1 registers the edited relationship information and setting information in the selected component information group, and updates the content displayed on the display unit 21 to a screen 214. The screen 214 is a display screen for the component information registered in the selected component information group. When the original component information group is designated as the registration destination of the edited relationship information and setting information, the information management apparatus 1 overwrites the unedited relationship information and setting information with the edited relationship information and setting information. FIG. 20 illustrates the example in which Z-System is selected as the registration destination where the unedited relationship information and setting information are overwritten with the edited relationship information and setting information.

When a component information group different from the original component information group is selected as the registration destination of the edited relationship information and setting information, the information management apparatus 1 duplicates the component information associated with the edited relationship information and setting information and additionally registers the duplicate component information in the selected component information group together with the edited relationship information and setting information. FIG. 20 illustrates the example in which I-System is selected as the registration destination where the duplicate component information and the edited relationship information and setting information are additionally registered in Z-System. Note that the correspondence among the relationship information, the setting information, and the component information does not change even when the relationship information and the setting information are edited. Thus, the component information associated with the edited relationship information and setting information is identical to the component information associated with the unedited relationship information and setting information.

Note that an erroneous operation or the like performed by the user can cause an inconsistency between the edited relationship information and the edited registration destination. In the operation illustrated in FIG. 20, for example, there can occur a case where other component information as the mater information of the component C (component information C) does not exist in the component information group selected as the registration destination or a case where the granularity of the component information designated as the mater information of the component C is finer than the granularity of the component C. When such a case occurs, the information management apparatus 1 does not register information in the component information group selected as the registration destination but prompts the user to perform re-editing, for example, by displaying a warning screen on the display unit 21. The information management apparatus 1 displays the registration destination selection screen or the edit screen 212 on the display unit 21 after making a notification that prompts the user to perform re-editing.

When a new component information group is selected, the information management apparatus 1 displays a screen 215 on the display unit 21 in order to allow the user to enter the name of the component information group (new component information group) in which the edited relationship information and setting information are to be registered. Upon detecting that the user has finished entering the name of the component information group, the information management apparatus 1 registers the edited relationship information and setting information in the new component information group whose name is determined. At this time, the information management apparatus 1 duplicates the component information associated with the edited relationship information and setting information, and registers the duplicate component information in the new component information group. That is, the information management apparatus 1 registers the edited relationship information and setting information and the component information (duplicate component information) in the new component information group. Note that the correspondence among the relationship information, the setting information, and the component information does not change even when the relationship information and the setting information are edited. Thus, the component information associated with the edited relationship information and setting information is identical to the component information associated with the unedited relationship information and setting information. The user can thus create another component information group by selecting the new component information group as the destination in which the edited relationship information and setting information are registered and by diverting the component information registered in the data server 30.

<Other Operations>

The information management apparatus 1 can output the component information 311 registered in the data server 30 to an external device. When detecting that an operation of providing an instruction to output the component information 311 registered in the data server 30 to an external device is performed by the user, the information management apparatus 1 outputs the component information 311 designated by the user together with the setting information 312 and the relationship information 313 associated with the component information 311 to an external storage area specified by the user such as a specific area in an external memory connected to the external memory connection unit 23. When selecting the component information 311 to be output to an external device, the user causes the component information 311 that needs to be output to an external device to be displayed on the display unit 21 by following the procedure described in the component information browsing operation or the like, and selects one or more pieces of the component information being displayed. In a case where the information management apparatus 1 is implemented by a personal computer, the information management apparatus 1 can allow the user to specify a specific storage area on a hard disk incorporated in the personal computer as the output destination of the component information 511, the setting information 312, and the relationship information 313. The external memory connection unit 23 operates as an information output unit when the external memory is the output destination of the component information 311, the setting information 312, and the relationship information 313. The output unit 25 operates as the information output unit when the hard disk in the information management apparatus 1 is the output destination of the component information 311, the setting information 312, and the relationship information 313.

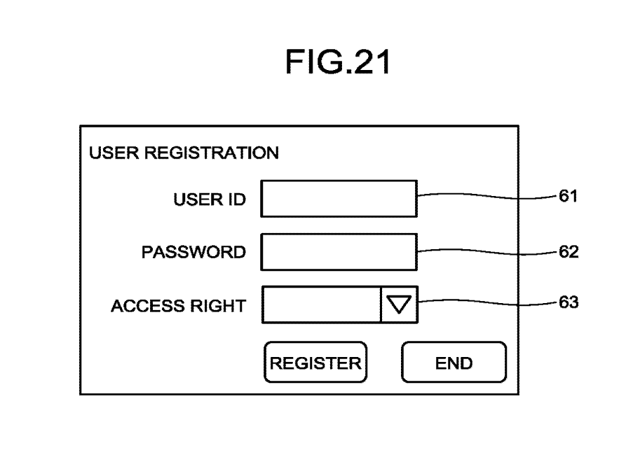

The information management apparatus 1 may set the access rights individually for each user and limit the functions that can be used by each user. The access rights can be set by an administrator of the information management system 100 or the like. The information management apparatus 1 gives permission to set the access rights when determining that the user has administrator rights in the user authentication operation performed at the start of the operation. The information management apparatus 1 displays a menu screen for setting the access rights on the display unit 21 upon detecting that an operation that starts setting the access rights is performed by the user having the administrator rights. For example, the information management apparatus 1 displays a menu screen illustrated in FIG. 21 on the display unit receives an input of required information in the user ID input field 61 and the password input field 62, receives the designation of the access rights when a selection button 63 is pressed, and then registers the input information in the user data storing unit of the data server 30. The access rights can be set at, but is not limited to, two levels: a level that only allows browsing of information registered in the data server 30 and a level that allows the use of all the functions such as registration of information in the data server 30 and browsing and editing of information registered in the data server 30. In the information management apparatus 1, the user management unit 24 performs the access right setting operation.

As described above, the information management system configured to include the information management apparatus according to the present embodiment manages the component information that is the modularized information related to the FA system and associates, with each piece of the component information to be managed, the relationship information that is configured to allow one to see the master-slave relationship with other component information. Moreover, when displaying each piece of component information managed by the information management system on the display unit, the information management apparatus reproduces the master-slave relationship between the component information on the display screen on the basis of the relationship information associated with each piece of the component information. As a result, the user can easily understand the relationship between the component information managed by the information management apparatus system and efficiently reuse the information used in the FA system.

Moreover, the information management apparatus according to the present embodiment manages the component information, the setting information, and the relationship information in association with one another and, when instructed to output the managed component information to an external device, outputs the designated component information together with the setting information and the relationship information associated therewith. Thus, when diverting the component information, the user need not designate the setting information and the relationship information associated with the component information to be diverted; therefore, the workload involved in the operations can be reduced and an occurrence of an erroneous operation (mis-selection of the setting information and relationship information to be output) can be prevented.

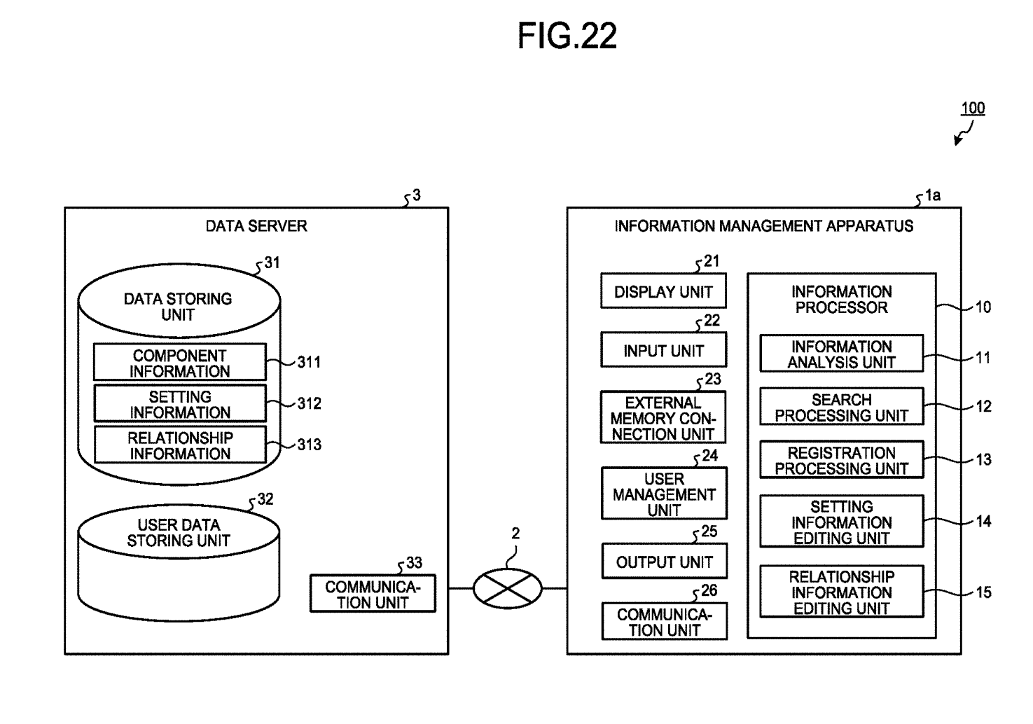

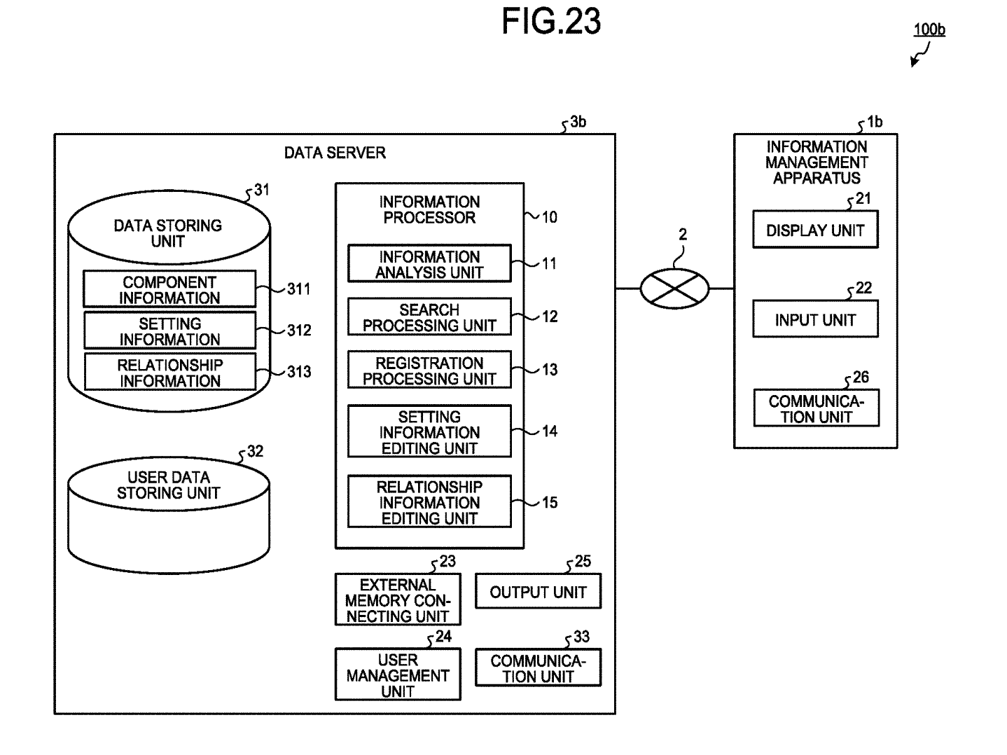

Note that the information management apparatus configured to include the data server 30 is described in the present embodiment only as an example. It is possible to employ such a configuration that the data server 30 is external to the information management apparatus 1, i.e., the data server 30 and the information management apparatus excluding the data server 30 are separate independent apparatuses, so as to manage the component information described above by a plurality of apparatuses. FIGS. 22 and 23 illustrate examples in which the component information is managed by a plurality of apparatuses

FIG. 22 is a diagram illustrating an example of the configuration of the information management system 100 that manages the component information. The information management system 100 is configured to include an information management apparatus 1a and a data server 3. The information management apparatus 1a and the data server 3 are connected via a network 2. The information management apparatus 1a includes the information processor 10, the display unit 21, the input unit 22, the external memory connection unit 23, the user management unit 24, the output unit 25, and a communication unit 26. The information processor 10, the display unit 21, the input unit 22, the external memory connection unit 23, the user management unit 24, and the output unit 25 are identical to the information processor 10, the display unit 21, the input unit 22, the external memory connection unit 23, the user management unit 24, and the output unit 25 included in the information management apparatus 1 illustrated in FIG. 1, respectively. The communication unit 26 communicates with the data server 3 via the network 2. The data server 3 is configured such that a communication unit 33 is added to the data server 30 illustrated in FIG. 1. The communication unit 33 communicates with the information management apparatus 1a via the network 2. Various operations related to the management of the component information by the information management system 100 illustrated in FIG. 22 are similar to those of the information management apparatus illustrated in FIG. 1 except that the information management apparatus 1a and the data server 3 exchange necessary information via the network 2.

FIG. 23 is a diagram illustrating an example of the configuration of an information management system 100b that manages the component information. The information management system 100b includes an information management apparatus 1b and a data server 3b. The information management system 100b is configured such that the data server 3b includes the information processor 10, the external memory connection unit 23, the user management unit 24, and the output unit 25 included in the information management apparatus is of the information management system 100 illustrated in FIG. 22. Various operations related to the management of the component information by the information management system 100b illustrated in FIG. 23 are similar to those of the information management apparatus 1 illustrated in FIG. 1 except that the information management apparatus 1a and the data server 3 exchange necessary information via the network 2.

The configurations illustrated in the aforementioned embodiment merely illustrate examples of the content of the preset invention, and can thus be combined with another known technique or partially omitted and/or modified without departing from the scope of the present invention.

### REFERENCE SIGNS LIST

1 information management apparatus; 2 network; 3, 3b, 30 data server; 10 information processor; 11 information analysis unit; 12 search processing unit; 13 registration processing unit; 14 setting information editing unit; 15 relationship information editing unit; 21 display unit; 22 input unit; 23 external memory connection unit; 24 user management unit; 25 output unit; 26, 33 communication unit; 31 data storing unit; 32 user data storing unit.

1. An information management apparatus comprising:
a registration processor to store, when registering component information obtained by modularizing information related to a system, relationship information indicating a relationship between the component information to be registered and one or a plurality of pieces of another component information and the component information to be registered in a storage while being associated with each other; and
a display screen generator to display each piece of the component information stored in the storage on a display by representing, on a basis of the relationship information, each piece of the component information in a form that allows a relationship with the another component information to be visually identified, wherein
the storage stores each piece of the component information in a storage area that includes a plurality of folders in a hierarchical structure, and
the registration processor generates the relationship information associated with the component information to be registered on a basis of the component information stored in a folder at a higher level than a folder in which the component information to be registered is stored.

2. The information management apparatus according to claim 1, wherein
the registration processor registers setting information on the system in the storage in association with the component information.

3. The information management apparatus according to claim 2, wherein
the display screen generator displays, on the display, each piece of the component information together with the setting information associated with the component information.

4. The information management apparatus according to claim 2, further comprising
an information editor to edit the relationship information and the setting information.

5. The information management apparatus according to claim 2, further comprising
an information transmitter to, when an operation of selecting and outputting one or more pieces of the component information stored in the storage to an output destination is performed, output, to an output destination designated in the operation, the component information selected in the operation and information associated with the component information selected in the operation.

6. The information management apparatus according to claim 2, further comprising
a search processor to search for setting information that includes a keyword input from an external device and display, on the display, component information associated with the found setting information and another component information related to the component information associated with the found setting information, among the component information stored in the storage.

7. The information management apparatus according to claim 1, wherein
the registration processor receives the component information to be registered in the storage from a storage area, checks whether or not relationship information indicating a relationship between the received component information and another component information exists in the storage area and, when the relationship information exists, acquires the relationship information from the storage area and registers the relationship information in the storage in association with the received component information.

8. The information management apparatus according to claim 1, wherein
the registration processor receives the component information to be registered in the storage from the storage area, checks whether or not the relationship information indicating a relationship between the received component information and another component information exists in the storage area and, when the relationship information does not exist, generates relationship information to be associated with the received component information and registers the relationship information in the storage in association with the received component information.

9. The information management apparatus according to claim 1, further comprising
a user manager to manage an access right of a user, wherein
a function available to the user is changed for each user in accordance with the access right set for each user.

10. The information management apparatus according to claim 1, further comprising:
a first display region to display one or a plurality of pieces of the component information;
a second display region to associate the component information with another component information; and
a component information mover to move the component information displayed in the first display region to the second display region, wherein
the registration processor registers a relationship between a plurality of pieces of the component information associated with each other in the second display region as relationship information.

11. The information management apparatus according to claim 1, further comprising:
a searcher to search for the component information stored in the storage; and
a displaying device to display the component information searched for by the searcher on the display, wherein
when the component information displayed on the display is selected, the display screen generator displays, on the display, a relationship of the component information related to the relationship information including the selected component information by representing the relationship in a visible form on a basis of the relationship information.

12. The information management apparatus according to claim 1, wherein
the display screen generator displays, for each of a plurality of pieces of the relationship information, the component information related to the relationship information in a visible form on the display, and is capable of displaying desired component information related to the relationship information displayed on the display in association with the component information on another relationship information, and
the registration processor registers a relationship between a plurality of pieces of the component information displayed by the display screen generator as new relationship information.

13. An information management method executed by an information management apparatus that includes a data server to store component information obtained by modularizing information related to a system, the method comprising:
receiving component information to be registered in the data server and associating the received component information with relationship information that indicates a relationship between the received component information and another component information;
registering, in the data server, the received component information and the relationship information associated with the received component information; and
displaying each piece of the component information stored in the data server on a display by representing, on a basis of the relationship information, each piece of the component information in a form that allows a relationship with the another component information to be visually identified, wherein
the data server stores each piece of the component information in a storage area that includes a plurality of folders in a hierarchical structure, and
the receiving includes generating the relationship information on a basis of the component information stored in a folder at a higher level than a folder in which the received component information is stored.

14. An information management system comprising:
a data server to store component information obtained by modularizing information related to a system in a storage area that includes a plurality of folders in a hierarchical structure; and
an information management apparatus to register the component information in the data server, wherein
the component information is stored in the data server in a state in which the component information is associated with relationship information indicating a relationship with another component information, and
the relationship information is generated on a basis of the component information stored in a folder at a higher level than a folder in which the component information associated with the relationship information is stored.

15. The information management apparatus according to claim 1, wherein
the relationship information is information indicating a master-slave relationship between the component information to be registered and the one or plurality of pieces of another component information.

16. The information management method according to claim 13, wherein
the relationship information is information indicating a master-slave relationship between the received component information and the another component information.

17. The information management system according to claim 14, wherein
the relationship information is information indicating a master-slave relationship with the another component information.
